(19) United States
(12) Patent Application Publication
(10) Pub. No.: US 2018/0018835 A1
(43) Pub. Date: Jan. 18, 2018

(54) ADAPTIVE GPS FOR ADVANCED TRACKING AND ROUTE REPLAY

(71) Applicant: Greenroad Driving Technologies Ltd., Beit Dagan (IL)

(72) Inventors: Roni Raviv, Nes Ziona (IL); Yuval Zorde, Gedera (IL)

(73) Assignee: Greenroad Driving Technologies Ltd., Beit Dagan (IL)

(21) Appl. No.: 15/431,996

(22) Filed: Feb. 14, 2017

Related U.S. Application Data
(60) Provisional application No. 62/362,138, filed on Jul. 14, 2016.

(51) Int. Cl. G07C 5/04; G01S 19/53; G01S 19/52; G07C 5/00; G01S 19/42

(52) U.S. Cl. CPC G07C 5/04; G07C 5/004; G01S 19/42; G01S 19/52; G01S 19/53

(57) ABSTRACT

For a driving session that includes maneuver events associated with a vehicle, each maneuver event being defined as a movement of the vehicle from a start position to an end position with an associated start time and end time, a method includes sending an anchor GPS message for each maneuver event. The anchor GPS message includes an anchor fix that includes fix, time, speed and heading with no delta modulation. Subsequent GPS messages are sent with delta modulations of the fix, time, heading and speed relative to the anchor fix.

### FIELD OF THE INVENTION

The present invention relates generally to driver monitoring systems, and particularly to a driver monitoring system with an adaptive GPS for advanced tracking and route replay.

### BACKGROUND OF THE INVENTION

Driver monitoring systems are capable of supervising the way a vehicle is being driven. Most monitoring systems capture real-time data and provide the driver of the vehicle and/or a fleet manager with an objective evaluation of the driving performance. Most monitoring systems known in the art are used to confirm whether the driver drives safely by facilitating the collection of qualitative and quantitative information related to factors that contribute to the occurrence of road accidents. In addition, monitoring systems may also be used to analyze other aspects of the driver's driving performance such as fuel consumption, driving habits, eco driving and more.

The physical operation of the vehicle is monitored through various sensors in operative connection with the vehicle or machine data bus. Sensors can be in direct communication with a monitoring/recording device. Sensors include, without limitation, accelerometers, gyros, fuel gauges, throttle position sensors, brake pedal position sensors, temperature sensors, and many more.

Driver monitoring systems typically rely on a global positioning system (GPS) to track the position of a vehicle and record the position of the vehicle during a driver safety event, such as travelling above the speed limit, unsafe lane changing, panic braking, and many others.

Obtaining the vehicle position is referred to as a GPS fix (including acquiring satellite signals and navigation data, and calculating the position). In prior art driver monitoring systems, GPS fix messages are sent from the GPS unit to the driver monitoring system host after a certain time interval. The longer the time interval, the less data is sent; this can save on bandwidth and reduce data processing time and resources. However, there this has serious drawbacks: longer time intervals may result in a difference of several kilometers between GPS fixes. The result is the driver monitoring system has no information of the vehicle path between such long time intervals. The system is incapable of tracking vehicle locations, especially in urban environments with small streets. The information send to the system does not provide sufficient resolution to enable landmark geo-fencing and the accuracy of route replay is seriously impaired (see FIG. 3). However, using very short time intervals between GPS fixes increases the data being sent and results in greater processing time and cost.

Street navigation devices may employ a “snap to” feature. The GPS communicates with different GPS satellites, calculates vehicle position, and compares the position to a database of roads. If the calculated position is close within a predetermined tolerance to the road, the GPS will assume the vehicle is exactly on the road. However, in real-life situations, especially for driver safety monitoring systems, the true exact position is important.

### SUMMARY OF THE INVENTION

The present invention seeks to provide an improved driver monitoring system with an adaptive GPS for advanced tracking and route replay, as is described more in detail hereinbelow. In particular, the present invention seeks to improve the GPS performance (e.g., resolution and accuracy) at a small increase of data consumption. For example, the invention can achieve an 8-fold increase in resolution with just double the data. The invention minimizes the time latency associated with unit time and GPS time. The invention achieves better tracking, landmark identification, route replay accuracy, snap to road accuracy, and higher resolution event information at faster times.

The invention is applicable for any positioning system, such as but not limited to, GPS, GLONAS, GNSS or any combination thereof.

### BRIEF DESCRIPTION OF THE DRAWINGS

The present invention will be understood and appreciated more fully from the following detailed description taken in conjunction with the drawings in which:

FIG. 1 is a simplified illustration of a method for sending GPS fixes, in accordance with a non-limiting embodiment of the present invention;

FIG. 2 is a simplified illustration of a method for sending GPS fixes, including adapting decisions when to sample and send GPS anchor fixes and to perform delta modulations thereof, in accordance with a non-limiting embodiment of the present invention;

FIG. 3 is a map illustrating tracking a vehicle route with a GPS system of the prior art; and

FIG. 4 is a map illustrating tracking a vehicle route with a GPS system of an embodiment of the present invention.

### DETAILED DESCRIPTION OF EMBODIMENTS

The present invention provides a method for adaptive GPS tracking of a vehicle. The method is applicable for a driver monitoring system used to analyze driver's driving performance, the system including various sensors in operative connection with the vehicle or machine data bus, including without limitation, accelerometers, gyros, fuel gauges, throttle position sensors, brake pedal position sensors, temperature sensors, and many more.

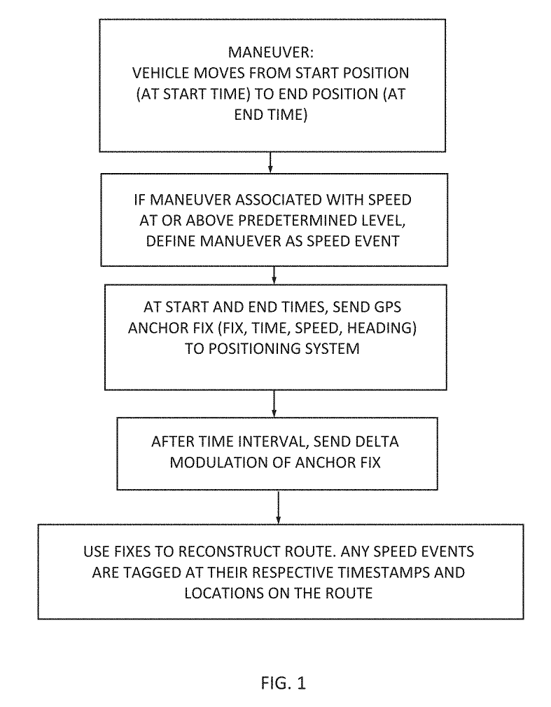

Reference is made to FIG. 1. During a driving session, the vehicle makes maneuvers, such as going forward, changing lanes, swerving, etc. The maneuvers are detected by the vehicle sensors.

A maneuver event is defined as a movement of the vehicle from a start position to an end position (with an associated start time and end time). A speed event is a maneuver event associated with a speed detected by the sensors as a speed of various predefined safe or unsafe levels.

An anchor GPS message is defined as a GPS fix for a reference point (anchor).

In accordance with an embodiment of the invention, every maneuver event includes an anchor GPS message. If no valid GPS sample is available for the maneuver event, the attached GPS fix field is nulled.

With every start and end of a speed event, the GPS unit sends its related GPS location. With the end speed event command, the GPS unit sends the following information:

a. end speed event command.

b. maximum speed location inside the speed event.

c. GPS location of the end speed event.

GPS data is removed from the ECM (engine control module) messages. The unit health is monitored with periodic messages that include extended GPS data (e.g., HDOP—Horizontal Dilution of Precision).

The vehicle GPS messages for safety events or maneuvers are sent from the vehicle GPS unit with positional fix, time, speed and heading with no delta modulation. This is the anchor fix. Afterwards, the system sends GPS messages with delta modulations of the fix (i.e., positional fix), time, heading and speed relative to the anchor fix (e.g., delta modulations of up to seven or any other number of previous fixes). All the fixes are used to reconstruct the route. Any speed events are tagged at their respective timestamps and locations on the route.

GPS health data is sent periodically, such as part of unit health messages. All GPS fixes are utilized by the backend as fixes.

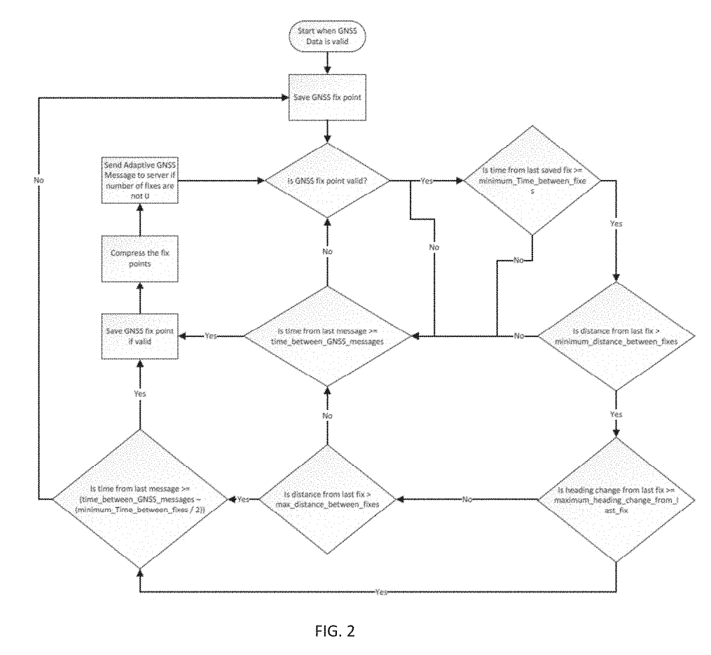

Reference is now made to FIG. 2, which illustrates an example of adapting decisions when to sample and send GPS anchor fixes and to perform delta modulations thereof. The invention provides an adaptive decision when to sample the GPS for the most efficient significant fixes. A compression algorithm may be used for minimizing the data transmission, particularly useful for a cellular network or any transmission with limited bandwidth. The compressed data is then reconstructed to provide the fixes in an optimal way to replay the route. The route may be reconstructed and displayed in a convenient format, such as but not limited to, a movie of the vehicle on route with snap to road for tracking purpose.

In one non-limiting embodiment, the system sends a number of GPS fixes (e.g., up to 8 GPS fixes) in binary format to the server. The number of GPS fixes in the message may be determined by an internal algorithm at the unit. The algorithm may decide which GPS is interesting and which is not according to a set of dedicated external parameters.

The invention thus provides an “elastic” GPS that improves tracking while saving data. The data may be sent as an aggregate GPS message with multiple points sent together in one message. The frequency of sending the messages may be preset or modified during use. The conditions for choosing GPS points to save may be based on Heading and Distance (or other parameters) compared with the previous point. The message sent to the server may contain one anchor point with full coordinates, whereas the rest of the points may be sent as gaps from each other, starting from the anchor fix.

Referring to FIG. 2, the fix point (e.g., GNSS fix point) is saved after determining the GNSS data is valid. If the GNSS fix point is valid, the algorithm checks if the time from the last saved fix is ≧the minimum time between fixes. (This minimum time may be set to prevent fixes overflow.) If this condition is met, then the algorithm checks if the distance from the last fix is ≧the minimum distance between fixes. This may ensure that fixes in the same location will not be duplicated. If this condition is met, then the algorithm checks if the heading change from the last fix is ≧the maximum heading change from the last fix. If this condition is met, then the algorithm checks if the time from the last message is ≧the time between GNSS messages (per the GNSS message frequency) and which may be, for example, half the minimum time between fixes.

If all these conditions are met, the GNSS fix point (anchor fix) is saved. The data may then be compressed and an adaptive GNSS message is sent to the server.

In one embodiment, if the GNSS fix point had not been valid, then the algorithm checks if the time from the last message is ≧the time between GNSS messages. If yes, the GNSS fix point (anchor fix) is saved. The data may then be compressed and an adaptive GNSS message is sent to the server.

The elastic GPS algorithm monitors the change in heading and distance from the previous point taken (e.g., every 1 second), and decides whether to save the location or not. In case the location has been saved, it may become the point of reference for the next decision making.

The next location may not be saved if the last saved location was taken in less than a certain time interval (e.g., 15 seconds (default interval)), which may be the message-time-interval/8.

Every message-time-interval (e.g., 2 minutes default) and all saved points may be compiled and compressed into one message and sent to the server. The last saved point may be sent along with its full data, latitude, longitude, speed, heading, and time stamp. The remaining points may be sent as gaps, starting from the previous location point, and going back in time. Since every gap value has only one byte, the real gaps may be divided by a Lat-Gap-Divider and Long-Gap-Divider. The gap dividers may be calculated in the device in such a way that when the true points are restored from these gaps, error may be minimal. The device may decompress the message as if the device were the server. The device may evaluate all possible gap dividers and eventually choose the ones resulting in minimal errors.

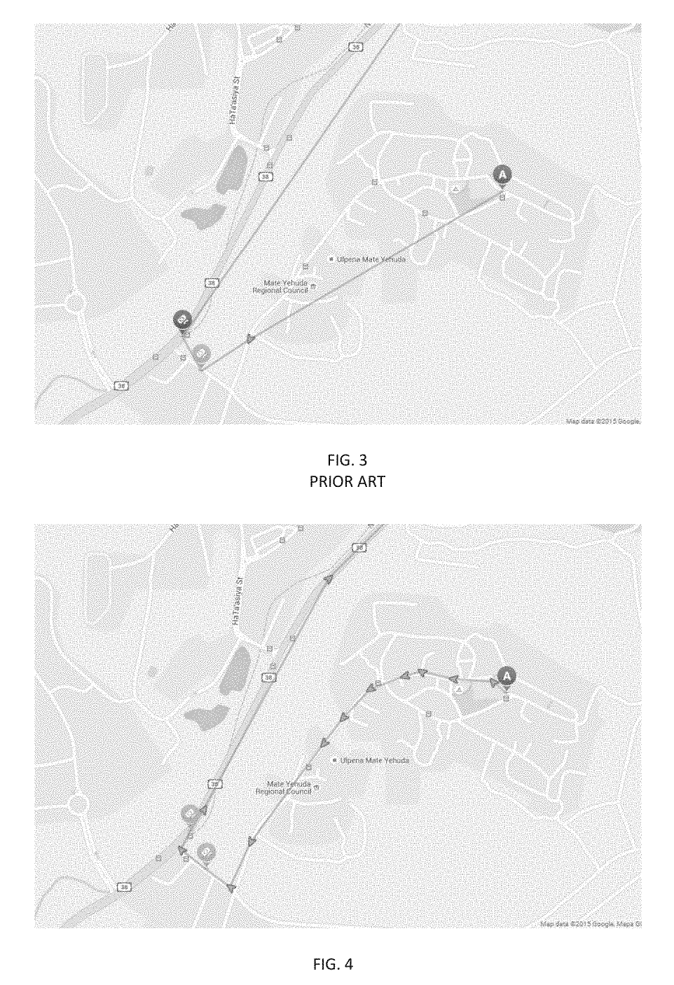

FIG. 4 illustrates reconstruction of a route using the present invention. As opposed to the prior art of FIG. 3, the present invention provides an accurate replay of the vehicle faithfully on the actual route traveled. For example, the invention can achieve an 8-fold increase in resolution with just double the data. The invention minimizes the time latency associated with unit time and GPS time. The invention achieves better tracking, landmark identification, route replay accuracy, snap to road accuracy, and higher resolution event information at faster times.

What is claimed is:

1. A method comprising:
for a driving session that includes maneuver events associated with a vehicle, each maneuver event being defined as a movement of the vehicle from a start position to an end position with an associated start time and end time, the method comprises sending an anchor GPS message for each maneuver event, the anchor GPS message comprising an anchor fix that includes positional fix, time, speed and heading with no delta modulation; and
sending subsequent GPS messages with delta modulations of the positional fix, time, heading and speed relative to the anchor fix.

2. The method according to claim 1, wherein at a start and an end of a maneuver event associated with an unsafe speed, sending related GPS location for the start and the end.

3. The method according to claim 2, wherein at the end, information sent comprises:
a. end speed event command.
b. maximum speed location inside the speed event.
c. GPS location of the end speed event.

4. The method according to claim 1, comprising removing GPS data from ECM (engine control module) messages.

5. The method according to claim 1, comprising monitoring unit health with periodic messages that include extended GPS data.
